(19) United States
(12) Patent Application Publication
(10) Pub. No.: US 2004/0200427 A1
(43) Pub. Date: Oct. 14, 2004

(54) WATER FLOW SYSTEM

(76) Inventor: Neal Dulaney, Santa Cruz, CA (US)

Correspondence Address: PEARNE & GORDON LLP, 1801 EAST 9TH STREET, SUITE 1200, CLEVELAND, OH, 44114-3108, US

(21) Appl. No.: 10/786,695

(22) Filed: Feb. 25, 2004

Related U.S. Application Data
(60) Provisional application No. 60/449,882, filed on Feb. 25, 2003.

(51) Int. Cl. A01K 63/04

(52) U.S. Cl. 119/261

(57) ABSTRACT

A modular water flow system for an aquarium comprising a pump, a water intake system, and a water return system. The water flow system includes at least one valve assembly to manage at least one of the water return system and the water intake system to regulate a flow rate. The water flow system includes an overwall assembly unit comprising an interior portion and an exterior portion rotatably coupled by a link.

### CROSS-REFERENCE TO RELATED APPLICATION

This application claims the benefit of U.S. patent application 60/449,882, the contents of which are incorporated herein by reference.

### BACKGROUND OF THE INVENTION

1. Field of the Invention

The present invention is directed to a modular water flow system for use with an aquarium.

2. Description of Related Art

Aquariums have been around for a long time. Attached filters are used to maintain an aquarium as a clean and safe habitat for aquatic life. The invention can provide the aquarist with the option of using a modular, highly customizable water flow system such as the one described hereafter. The modular water flow system can allow the aquarist to manipulate the flow of water into many desired patterns. The modular water flow system can attach to a filter or a pump to create a propulsive force. The water flow can create an aesthetic effect that can also be beneficial to the health of the aquatic environment.

### BRIEF SUMMARY OF THE INVENTION

The present invention includes a modular water flow system for an aquarium comprising a pump, a water intake system having at least one inlet wherein the intake system pulls water in through the inlet due to a propulsive force created by the pump, and a water return system having at least one outlet wherein the return system permits the water to return to the aquarium form the outlet. The invention also includes at least one valve assembly to manage at least one of the water return system and the water intake system to regulate a flow rate. The modular water flow system also includes an overwall assembly unit comprising an interior portion and an exterior portion rotatably coupled by a link. The modular water flow system allows the aquarist to manipulate the flow of water into any pattern so desired creating an aesthetic effect that can also be beneficial to the health of the aquatic environment.

### BRIEF DESCRIPTION OF THE SEVERAL VIEWS OF THE DRAWINGS

The invention can be understood with reference to the following drawings. The components in the drawings are not necessarily to scale. Also, in the drawings, like reference numerals designate corresponding parts throughout the several views.

FIG. 1A and FIG. 1B combine to form an isometric view of a modular water flow system for an aquarium according to an embodiment of the present invention;

FIG. 2 is a detail view of a portion of a water intake system that is a portion of FIG. 1;

FIG. 3 is a detail view of an elbow bracket;

FIG. 4 is a detail view of a tee bracket;

FIG. 5 is a detail view of a valve assembly;

FIG. 6 is a detail view of a coupling bracket;

FIG. 7 is a detail view of an overwall assembly;

FIG. 8 is a detail view of a spray bar;

FIG. 9 is a detail view of a ball/socket assembly;

FIG. 9A is a close-up of how the balls and sockets of FIG. 9 interlock;

FIG. 10 is a detail view of a hydrojet; and

FIG. 10A is a detail view of a cap.

### DETAILED DESCRIPTION OF THE INVENTION

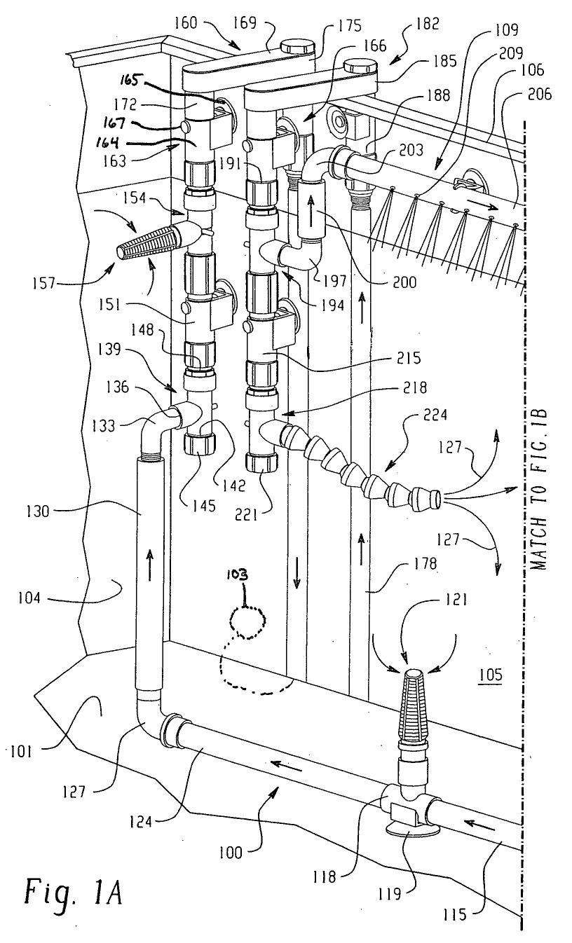

A typical aquarium 106 includes a base 101 two side walls 104, a front wall and a rear wall 105. In FIG. 1A and FIG. 1B, only one side wall 104 is shown, however, the opposite side wall is typically similar to the side wall 104 visible in FIG. 1A. Also, the front wall is typically similar to the rear wall 105. An aquarium is constructed generally as a tank for holding water and marine life. The invention is directed to a modular water flow system for creating desired water flow patterns in an aquarium. With reference to FIG. 1A and FIG. 1B, shown is an isometric view of a modular water flow system for an aquarium according to an embodiment of the present invention. A water intake system 100 generally has at least one inlet, such as the first inlet 112, second inlet 121, and third inlet 157 as shown in FIG. 1A and FIG. 1B.

The water intake system 100 has a number of connecting interchangeable pieces that create a modular system that is highly customizable by the aquarist. Examples of connecting pieces include, a first elbow bracket 102, a first tee bracket 118, a second elbow bracket 127, a third elbow bracket 133, and a coupling bracket 151, although, other connecting pieces could be used as appropriate. Between the connecting pieces are a number of pipes, such as a first pipe 115, a second pipe 124, and a third pipe 130. Also, between the connecting pieces can be other interchangeable modular parts. The interchangeable modular parts and connecting pieces can fit together by an interference fit, a friction fit, screwing together, or any other suitable way of being fit together.

There are a number of ways the various pieces of the modular water flow system can fit together. In the current embodiment, only some parts are interchangeable with other parts. For example, some parts can be screwed together; consequently, only parts with mating threads can be fit together in this way. Other parts fit together by friction fit, so any two pieces with the appropriate sizes can be coupled by friction fit. Consequently, in the current embodiment, only some parts can be interchangeably connected. However, in an alternative embodiment, all the parts could connect together in the same way (via friction fit, screwing together, etc.), thus making the assembly kit fully interchangeable.

The water intake system 100 can have at least one valve assembly to manage the water intake system. One example is a first valve assembly 139. The valve assemblies have multiple purposes such as to manage the rate at which the water enters the water intake system 100, to serve as a connection, like the coupling brackets, tee brackets, and elbow brackets, to serve as a splitter to split the water pathway into multiple pathways, to manage the rate at which water returns to the aquarium, or any other suitable use.

The water intake system 100 can be connected to an overwall assembly unit, such as the first overwall assembly unit 160. The overwall assembly unit can extend over one of the aquarium walls, for example the rear wall 105 as shown in the current embodiment. The overwall assembly unit can remove water from the aquarium 106 to be filtered if so desired. The overwall assembly that removes water from the aquarium can be attached to a filter then a second overwall assembly unit 182 to return the water to the aquarium 106. Alternatively, the first overwall assembly can be attached directly to a second overwall assembly unit 182 without a filter in between. In another alternative, the first overwall assembly unit 160 could be attached directly to a water return system 109, or any other suitable connecting piece.

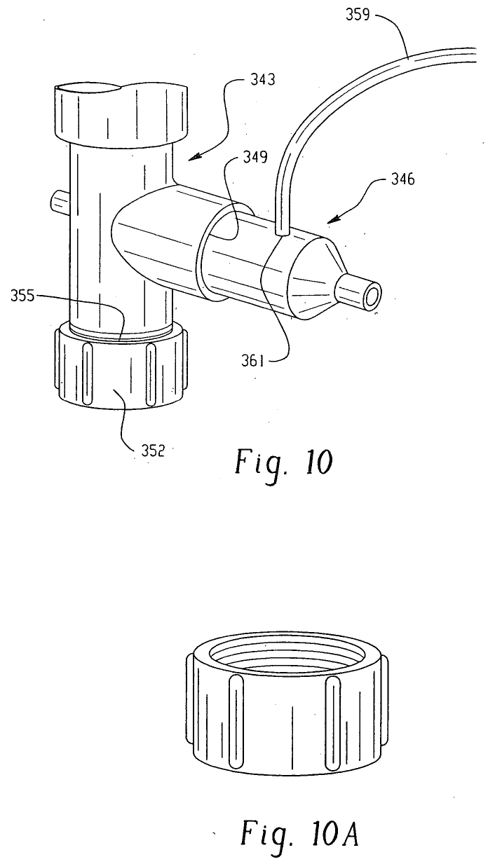

In the current embodiment, the second overwall assembly unit 182 is attached to a water return system 109. The water return system 109 generally returns water to the aquarium 106. The water return system 109 can include a number of components. Of these components, many can be the same as those used to create the water intake system 100, such as pipes, brackets, tee brackets, elbow brackets, and other interchangeable parts that connect the modular system. There can also be valve assemblies, such as the fourth valve assembly 218 that can be used to control the rate at which water is returned to the aquarium 106. Also, as previously mentioned, the valve assemblies can also be used as connection pieces to split the water return pathway into multiple pathways as the third valve assembly 194 is used to do. There are also many components that can be used to return the water to the aquarium 106, as customizable by the aquarist. Examples of these components include a spray bar 206, 212, a ball/socket assembly 224, a hydrojet 346 (FIG. 10), or any other suitable device that could return water to an aquarium 106.

In the current embodiment, many of the connecting pieces (e.g. tee brackets, elbow brackets) and many of the other parts (e.g. pipes, spray bars) have attachment mechanisms coupled thereto. The attachment mechanisms greatly improve the stability of the water flow system. As a result, no matter how the aquarist decides to adjust the water flow, the parts should stay in place. This enhances customizability because stability of the system is not a consideration in how the system will be set up. The attachment mechanisms can be coupled to the connecting pieces or other parts in a number of ways.

In one embodiment, an attachment mechanism is attached to a collar that is larger in size than the part it is collared around. Consequently, the collar can rotate axially around the part that is collared by the collar. For example, in FIG. 1A, a collar 164 is collared around a pipe (not visible in drawing) that connects a second valve assembly 154 to the first link 169. The diameter of the collar 164 is larger than the diameter of the pipe that the collar 164 is collared around. Thus, the collar 164 can spin axially around the pipe so a suction cup 165 can attach to the rear wall 105 to secure the pipe to the aquarium wall. The back of the suction cup 165 includes a protrusion formed as a flange. The collar 164 can also have a protrusion 167 formed as a flange. This protrusion 167 can allow one collar to attach to another collar creating a multi-layer type arrangement. In the current embodiment, the protrusion 167 is similar in size to the protrusion on the back of the suction cup so that a suction cup or a second collar can be attached to the collar in the same way as explained next.

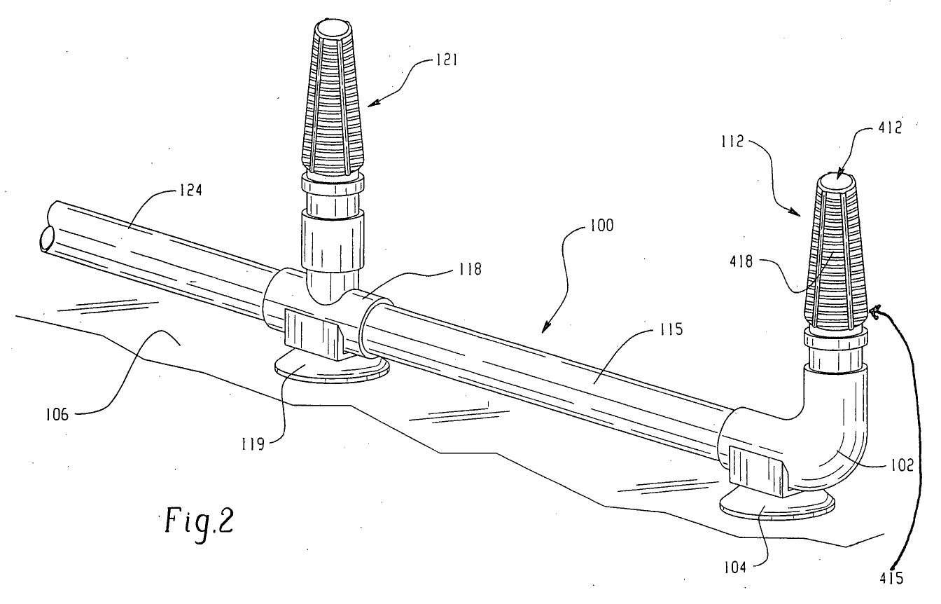

Referring to FIGS. 3 and 1A, shown is an example of how an attachment mechanism such as a suction cup can be semi-permanently attached. As the drawing shows, the protrusion of the attachment mechanism 245 can slide into the opening 247 in the bracket 246 so the attachment mechanism 245 is securely attached to the elbow bracket 242, yet is removable thus creating a semi-permanent attachment. Also, instead of an attachment mechanism 245 being attached to the elbow bracket 242, a collar can attach in the same way, by sliding the protrusion 167 into the opening 247 in the bracket 246. Thus creating a multi-layer type arrangement.

In the alternative, an attachment mechanism can be coupled directly to any of the modular pieces. For example, any connecting piece, such as a coupling bracket, can come with an attachment mechanism, such as a suction cup, attached directly to the coupling bracket. The aquarist can then choose to use a coupling bracket with a suction cup if the aquarist wants to stabilize that portion of the modular water flow system.

The modular water flow system can be packaged together as a kit for assembly. The kit could include any of a number of parts that could comprise a water intake system having at least one inlet adapted to pull water in through the inlet due to a propulsive force, a water return system having at least one outlet adapted to permit the water return system to return water to the aquarium, a valve assembly unit, at least one connecting piece, at least one pipe, overwall assembly unit, and any other pieces that could be used to create the desired modular water flow system.

According to the embodiment of FIG. 1A and FIG. 1B, a first inlet 112 pulls in water due to the propulsive force created by the attached pump 103. The first inlet 112 is coupled to a first pipe 115 by a first elbow bracket 102. After entering the first inlet 112, the water then travels through the first pipe 115. At the other end, the first pipe 115 is coupled to a first tee bracket 118 that connects the first pipe 115 to a second inlet 121 and a second pipe 124. The water continues to travel through the second pipe 124, then through a second elbow bracket 127 that connects to a third pipe 130. The third pipe 130 is connected to a third elbow bracket 133 which is connected to a first opening 136 in a first valve assembly 139. A second opening 142 is sealed off with a cap 145. A third opening 148 in the first valve assembly 139 is connected to a first coupling bracket 151 which connects the first valve assembly 139 to a second valve assembly 154. The second valve assembly 154 has a third inlet 157 attached thereto that brings in more water due to the propulsive force created by the attached pump 103. This second valve assembly 154 is attached to a first overwall assembly unit 160.

The first overwall assembly unit 160 couples an interior portion 163 of the water intake system 100 to an exterior portion 166 via a first link 169. The first overwall assembly unit 160 extends over the rear wall 105, allowing the water to flow outside of the aquarium 106. The first link 169 has a first inlet port 172 and a first outlet port 175 of the water intake system 100. The first inlet port 172 is rotatably coupled to the interior portion 163 of the first link 169. The first outlet port 175 is rotatably coupled to the exterior portion 166 of the first link 169. The water flows through the first overwall assembly unit 160 traveling through the interior portion 163, then through the first link 169, then through the exterior portion 166. At this point, the water can circulate through an optionally attached filter or flow back unfiltered. The water can then begin its reentry to the aquarium 106 through the exterior return portion 178.

The water then travels through a second overwall assembly unit 182 that couples the exterior return portion 178 to a water return system 109 via a second link 185. In the current embodiment, the second overwall assembly unit 182 extends over the rear wall 105 of the aquarium 106. The second link 185 has a second inlet port 188 and a second outlet port 191 of the water return system 109. The second inlet port 188 is rotatably coupled to the exterior return portion 178 of the water return system 109. The second outlet port 191 is rotatably coupled to a third valve assembly 194. The third valve assembly 194 is attached to a fourth elbow bracket 197. Some water flows through the fourth elbow bracket 197 whereas some water flow is split by the third valve assembly 197 so some of the water travels through a second coupling bracket 215.

The fourth elbow bracket 197 is connected to the fourth pipe 200, which is connected to a fifth elbow bracket 203. Attached on the other end of the fifth elbow bracket 203 is a first spray bar 206. The first spray bar 206 has at least one aperture 209 that returns water to the aquarium 106. Attached at the other end of the first spray bar 206 is a sixth elbow bracket 210. The sixth elbow bracket 210 couples the first spray bar 206 to a second spray bar 212 that returns water to the aquarium 106. In the current embodiment, the second spray bar 212 is the end of this portion of the water return system 109.

The water traveling through the second coupling bracket 215 then goes through a connected fourth valve assembly 218. The fourth valve assembly 218 has two additional openings. In the current embodiment, one of the openings is sealed with a second cap 221. However, any of a number of pieces could be attached to split the water flow further. The other opening is coupled to a ball/socket assembly 224. The ball/socket assembly comprises a number of interlocking balls and sockets that can be rotated in at least one direction to allow customizability in water flow pattern as shown by the arrows 127. Any of the openings of the valve assemblies can have any of a number of attachments coupled to the openings to create a desired water flow.

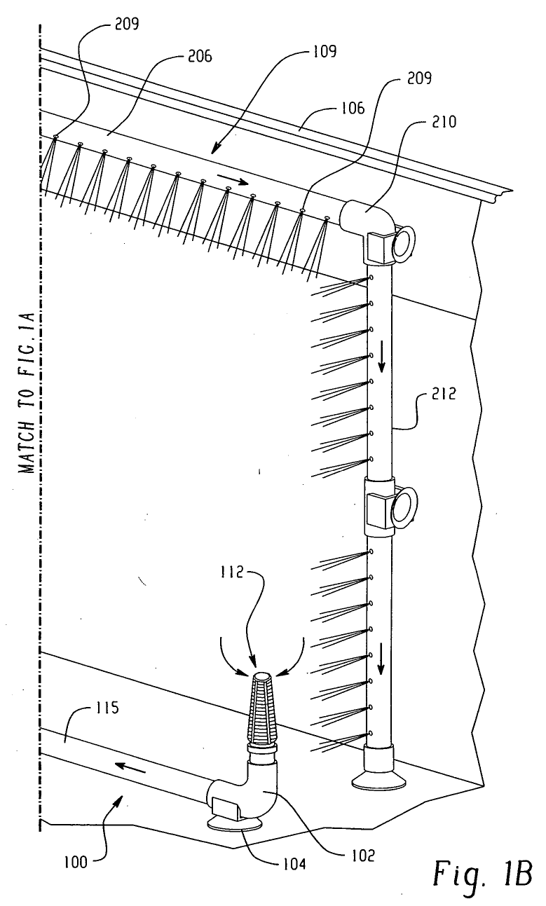

Referring next-to FIG. 2, shown is a detail view of a portion of the water intake system 100. The first inlet 112 is coupled to a first pipe 115 by a first elbow bracket 102. The first elbow bracket 102 is coupled to a first attachment mechanism 104. In the current embodiment, the attachment mechanism that is shown is a suction cup. Other attachment mechanisms could be used for this first elbow bracket 102 or any other connecting bracket or other modular piece discussed hereafter. The parts fit together by an interference fit, a friction fit, or any other suitable way of being fit together.

The water is drawn into the first inlet 112 due to a propulsive force caused by an attached pump 103 (FIG. 1A). The first pipe 115 is attached to a second pipe 124 and a second inlet 121 by a first tee bracket 118. The first tee bracket 118 is coupled to a second attachment mechanism 119. In the current embodiment, the attachment mechanism 119 is a second suction cup.

In the current embodiment, the inlets are conically shaped. For example, in the first inlet 112, the upper end 412 is narrower than the lower end 415. However, other shapes such as a cube, a ball, or other shapes can be used. There are slits 418 through which the water travels into the system through. The slits 418 serve to filter out bigger debris and to prevent marine life from being sucked into the water flow system. Slits 418 are only one example of a filtering entrance. Other examples that would serve the same function include circular holes, triangular holes, square holes, rectangular holes, notches, or any other aperture that would be functional to keep debris and marine life out of the water flow system.

Referring next to FIG. 3, shown is an example of an elbow bracket 242 that is coupled to an attachment mechanism 245. In the current embodiment, the attachment mechanism 245 is a suction cup. The elbow bracket 242 can connect any two pieces (e.g. a pipe 115 (FIG. 1), a inlet 112 (FIG. 1), a spray bar 206 (FIG. 1), a valve assembly 139 (FIG. 1)) together to help the aquarist customize the setup of the water flow system in any desired way. The embodiment of FIG. 3 shows a pipe 248 coupled to a spray bar 251.

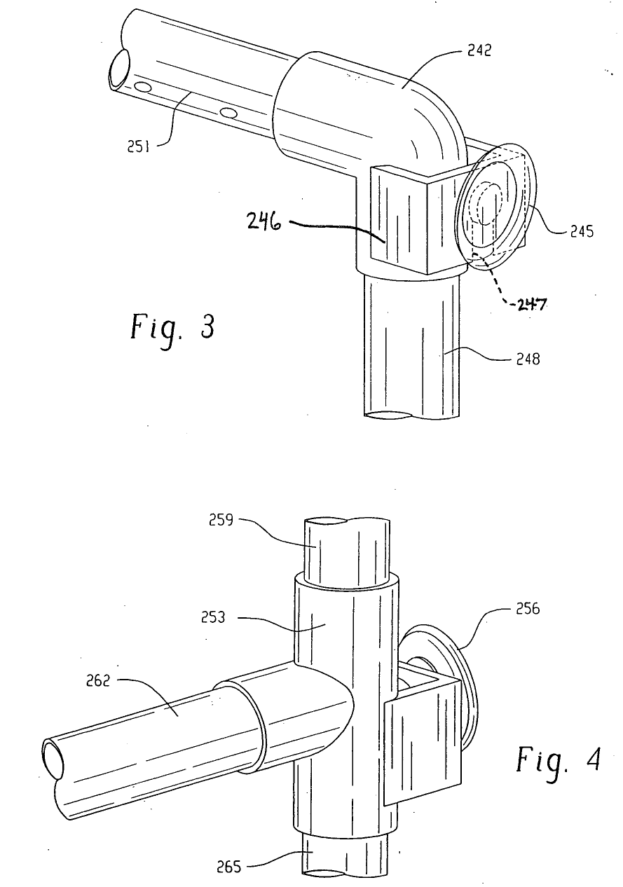

Referring next to FIG. 4, shown is an example of a tee bracket 253 that is coupled to an attachment mechanism 256. In the current embodiment, the attachment mechanism 256 is a suction cup. The tee bracket 253 can connect any three pieces (e.g. a pipe 115 (FIG. 1), a inlet 112 (FIG. 1), a spray bar 206 (FIG. 1), a valve assembly 139 (FIG. 1)) together to help the aquarist customize the setup of the water flow system in any desired way. The embodiment of FIG. 4 shows a first pipe 259 connected to a second pipe 262 and a third pipe 265.

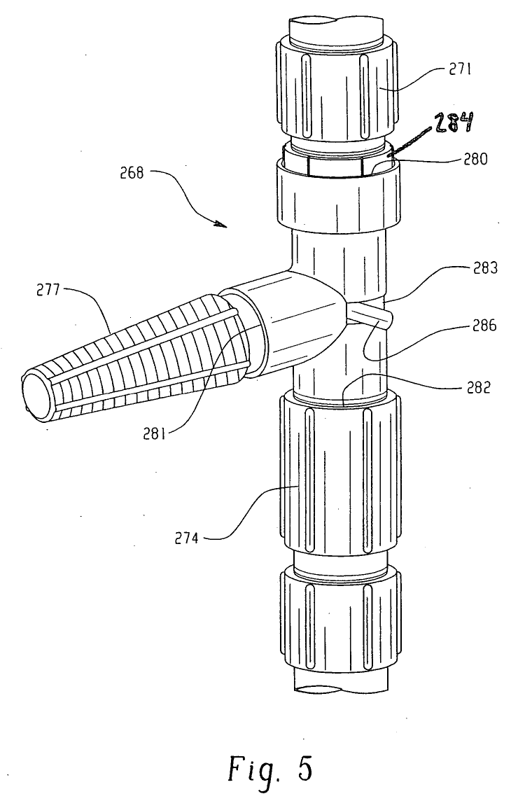

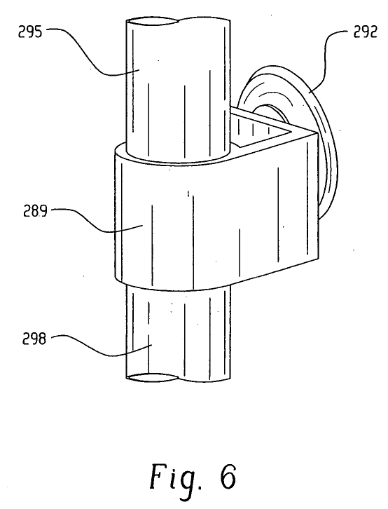

Referring next to FIG. 5, shown is an example of a valve assembly 268 that is connected to a first coupling bracket 271, a second coupling bracket 274, and an inlet 277. The first coupling bracket 271 is locked into connection with the valve assembly 268 by a lock ring 284. The lock ring 284 is threaded onto first opening 280 of the valve assembly 268 and screws into engagement with the mating part to lock together. The valve assembly manages the water intake system 100 (FIG. 1) and/or the water return system 109 (FIG. 1) by regulating a rate at which water is taken into the system and/or the rate at which the water returns to the aquarium 106 (FIG. 1). The valve assembly 268 can be coupled to the system by at least one connecting bracket (e.g. a coupling bracket 289 (FIG. 6), a tee bracket 253 (FIG. 4), an elbow bracket 242 (FIG. 3), or coupled to another valve assembly 268). The valve assembly 268 comprises one or more opening and a regulator 283 which regulates the rate at which the water returns to the aquarium 106 (FIG. 1); or the regulator 283 can regulate the rate at which water is taken into the system. In the current embodiment, there is a first opening 280, a second opening 281, and a third opening 282. Although the current embodiment of FIG. 5 has three openings, at least two openings are all that are required for a functional valve assembly 268.

The regulator 283 further comprises an adjustment mechanism 286 to alter the rate at which the water returns. In the present embodiment, the adjustment mechanism 286 is a knob. However, different adjustment mechanisms could be used, such as a handle, a lever, a switch, or any similar protrusion. In the current embodiment, the regulator 283 locks into place so the flow rate of water remains constant unless the aquarist adjusts the adjustment mechanism 286. When the adjustment mechanism 286 is fully open, the second opening 281 is fully open. When the adjustment mechanism 286 is fully closed, the second opening 281 is sealed off so as to stop the flow of water through that second opening 218. In between the fully open and fully closed positions lie variable water flow rates as chosen by the aquarist when the adjustment mechanism 286 is adjusted.

Referring next to FIG. 6, shown is an example of a coupling bracket 289 that is coupled to an attachment mechanism 292. In the current embodiment, the attachment mechanism 292 is a suction cup. The coupling bracket 289 can connect any two pieces (e.g. a pipe 115 (FIG. 1), a inlet 112 (FIG. 1), a spray bar 206 (FIG. 1), a valve assembly 139 (FIG. 1)) together to help the aquarist customize the setup of the water flow system in any desired way. The embodiment of FIG. 6 shows a first pipe 295 coupled to a second pipe 298.

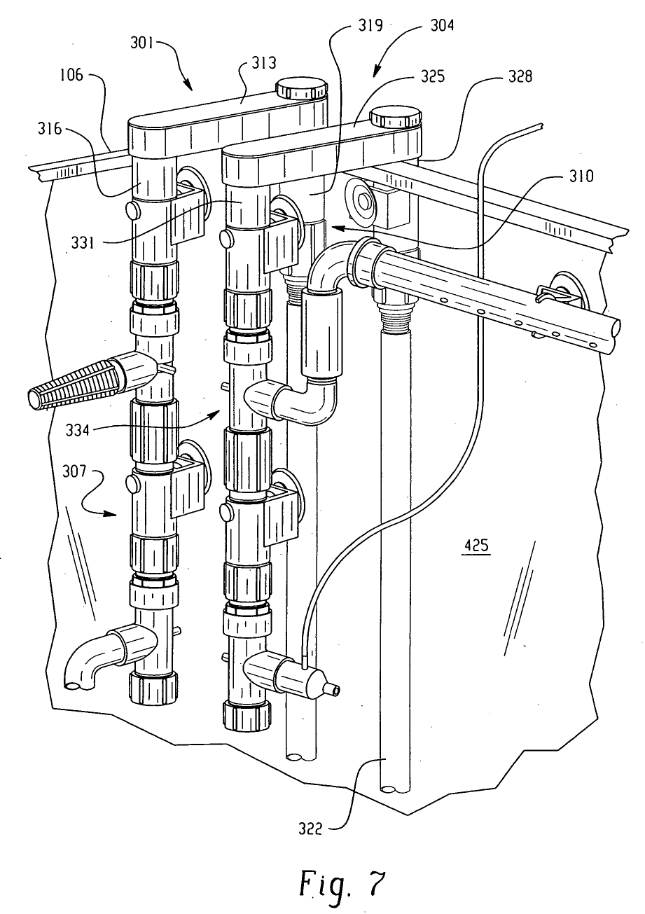

Referring next to FIG. 7, shown is an example of a first overwall assembly 301 that removes water from the aquarium 106 and a second overwall assembly 304 that returns water to the aquarium 106. The overwall assembly unit extends over one of the side walls of the aquarium 106, for example the rear wall 425, as shown in the current embodiment. While outside the aquarium 106, the water can pass through an attached filter system or return to the aquarium 106 unfiltered. The first overwall assembly unit 301 couples an interior portion 307 of the water intake system 100 (FIG. 1) to an exterior portion 310 via a first link 313. The first link 313 has a first inlet port 316 and a first outlet port 319. The first inlet port 316 is rotatably coupled to the interior portion 307 of the first link 313. The first outlet port 319 is rotatably coupled to the exterior portion 310 of the first link 313. The water flows through the first overwall assembly unit 301 traveling through the interior portion 307, then through the first link 313, then through the exterior portion 310. At this point, the water can circulate through an attached filter or flow back unfiltered.

The water then travels through a second overwall assembly unit 304 that couples the exterior return portion 322 to a water return system 109 (FIG. 1) via a second link 325. The second link 325 has a second inlet port 328 and a second outlet port 331. The second inlet port 328 is rotatably coupled to the exterior return portion 322 of the second link 325. The second outlet port 331 is rotatably coupled to a valve assembly 334 in the present embodiment. However, any of a number of devices, such as a tee bracket, coupling bracket, or other device could attach the second overwall assembly unit 304 to the water return system (FIG. 1). The inlet and outlet ports are rotatably coupled to allow the overwall assembly units to swivel, thus allowing close aquarium-to-wall positioning.

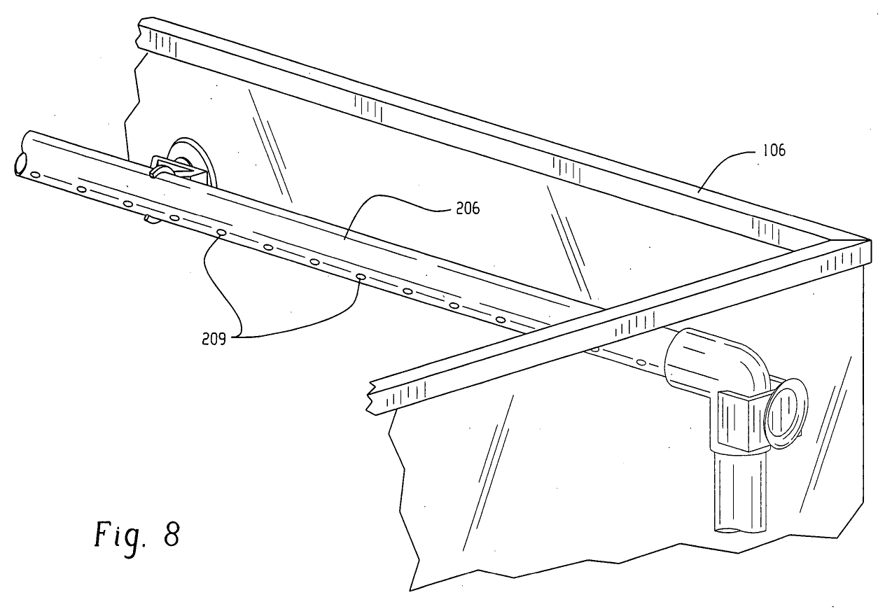

Referring next to FIG. 8, shown is a cutout view of a spray bar 206 that is a portion of FIG. 1. The spay bar 206 is part of the water return system 109 (FIG. 1). The spray bar has one or more apertures 209 that the water can return to the aquarium 106 through. In the current embodiment, the apertures are round, however, the shape is unimportant. The apertures can be round, square, triangular, slot-like, slits, or any other aperture that would be able to return water to the aquarium 106.

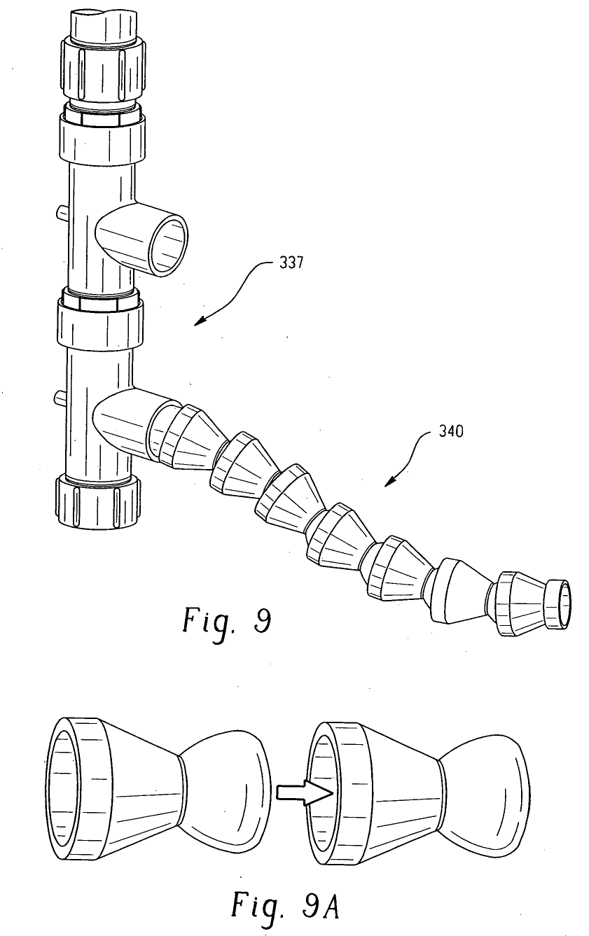

Referring next to FIG. 9, shown is a cutout view of a valve assembly 337 with a ball/socket assembly 340 attached thereto. The ball/socket assembly 337 comprises a number of interlocking balls and sockets that can be rotated in at least one direction to allow customizability in water flow pattern. FIG. 9A shows how the balls and sockets interlock.

Referring next to FIG. 10, shown is a cutout view of a valve assembly 343 with a hydrojet 346 attached to a first opening 349 and a cap 352 attached to a second opening 355. The cap 352 seals off the second opening 355 to prevent water from escaping the modular water flow system. In the present embodiment, the cap 352 is screwed onto the opening 355. However, many others attachment mechanisms, such as a snap-on cap, a clamp, or a latch, could couple the cap 352 to the second opening 355. The hydrojet 346 adds air to the water returning to the aquarium 106 (FIG. 1). A flexible tube 359 connects an aperture 361 in the hydrojet 346 to air outside the aquarium. A venturi force draws the air into the hydrojet 346 through the flexible tube 359. The flexible tube 359 is positioned above the aquarium water level. The air then mixes with the water flowing through the water flow system and exits the hydrojet 346 to enter the aquarium.

By assembling the components described herein, the user can direct water to desired locations in the aquarium and collect water at desired locations. Consequently, the user can manipulate the water flow into desired patterns. The components can be bundled together into a kit for assembly, to allow the user to pick and choose which parts would be best suited for the water flow desired.

Although the invention is shown and described with respect to certain preferred embodiments, it is obvious that equivalents and modifications will occur to others skilled in the art upon the reading and understanding of the specification. The present invention includes all such equivalents and modifications, and is limited only by the scope of the claims.

What is claimed is:

1. A modular water flow system for an aquarium comprising:
a pump;
a water intake system having at least one inlet wherein the intake system pulls water in through the inlet due to a propulsive force created by the pump;
a water return system having at least one outlet wherein the return system permits the water to return to the aquarium from the outlet; and
at least one valve assembly to manage at least one of the water return system and the water intake system to regulate a flow rate.

2. The modular water flow system of claim 1, wherein the water intake system, the water return system, and the at least one valve assembly are coupled by at least one connecting piece.

3. The modular water flow system of claim 2, wherein the at least one connecting piece further comprises at least one of the following:
a coupling bracket;
a tee bracket; and
an elbow bracket.

4. The modular water flow system of claim 2, wherein the at least one connecting piece is coupled to an attachment mechanism.

5. The modular water flow system of claim 4, wherein the attachment mechanism is a suction cup.

6. The modular water flow system of claim 1 further comprising an overwall assembly unit which couples an interior portion of the modular water flow system to an exterior portion of the modular water flow system via a link.

7. The modular water flow system of claim 6 wherein the link comprises an inlet port and an outlet port.

8. The modular water flow system of claim 7, wherein the inlet port is rotatably coupled to the exterior portion of the modular water flow system.

9. The modular water flow system of claim 7, wherein the outlet port is rotatably coupled to the interior portion of the modular water flow system.

10. The modular water flow system of claim 1 wherein the valve assembly further comprises:
one or more opening; and
a regulator which regulates the rate at which the water returns.

11. The modular water flow system of claim 10, wherein the regulator further comprises an adjustment mechanism to alter the rate at which the water returns.

12. The modular water flow system of claim 10 further comprising at least one cap which can seal at least one of the one or more openings.

13. The modular water flow system of claim 1 wherein the at least one valve assembly further comprises at least one attachment that fastens to the at least one opening.

14. The modular water flow system of claim 13 wherein the at least one attachment includes at least one of:
a hydrojet; and
a ball/socket assembly.

15. The modular water flow system of claim 14, wherein the ball/socket assembly comprises a number of interlocking balls and sockets that can be rotated in at least one direction to allow customizability in water flow pattern.

16. The modular water flow system of claim 1, wherein the water return system further comprises at least one spray bar having at least one aperture.

17. The modular water flow system of claim 1, further comprising at least one pipe connected on each end by at least one connecting piece and located between the water intake system and the water return system.

18. A modular water flow system for an aquarium comprising:
water intake means;
water return means; and
means for adjusting water return rate.

19. The modular water flow system of claim 18, further comprising:
a means for removing water from an interior portion of an aquarium to an exterior portion of the aquarium;
a means for returning water to the interior portion of the aquarium from the exterior portion of the aquarium;
a connection means for coupling the interior portion to the exterior portion of the aquarium.

20. The modular water flow system of claim 19, further comprising means for swiveling the connection means to facilitate positioning of the system.

21. An overwall assembly unit comprising:
an interior portion through which water can travel;
an exterior portion through which water can travel;
a link through which water can travel;
the exterior portion being rotatably coupled to the interior portion via the link;
the link further comprises an inlet port that the interior portion can be rotatably coupled thereto; and
the link further comprises an outlet port that the exterior portion can be rotatably coupled thereto.

22. At least one valve assembly to manage at least one of a water return system and a water intake system to regulate a flow rate comprising:
at least one opening; and
a regulator which regulates the flow rate.

23. The at least one valve assembly of claim 22, wherein the regulator further comprises an adjustment mechanism to alter the flow rate.

24. The at least one valve assembly of claim 22, further comprising at least one cap which can seal at least one of the openings.

25. The at least one valve assembly of claim 22, further comprising at least one attachment that fastens to at least one of the openings.

26. The at least one valve assembly of claim 25 wherein the at least one attachment includes at least one of:
a hydrojet; and
a ball/socket assembly.

27. The at least one valve assembly of claim 26, wherein the ball/socket assembly comprises a number of interlocking balls and sockets that can be rotated in at least one direction to allow customizability in water flow pattern.

28. A kit for assembly of a modular water flow system for an aquarium comprising:
a water intake system having at least one inlet adapted to pull water in through the inlet due to a propulsive force;
a water return system having at least one outlet adapted to permit the water to return to the aquarium from the outlet;
at least one valve assembly connectable to manage at least one of the water return system and the water intake system to regulate a flow rate;
at least one connecting piece; and
at least one pipe;
wherein the at least one connecting piece, the water intake system, the water return system, the valve assembly, and the pipe can be interchangeably connected in a modular way to allow the kit to be set up to create a water flow pattern as desired by an aquarist.

29. The kit for assembly of a modular water flow system for an aquarium of claim 28 further comprising at least one overwall assembly unit wherein the overwall assembly unit can be interchangeably connected in a modular way to the water intake system, the water return system, the valve assembly, the connecting piece, and the pipe.
